(19) United States
(12) Patent Application Publication
(10) Pub. No.: US 2026/0051079 A1
(43) Pub. Date: Feb. 19, 2026

(54) SELF-CALIBRATING CAMERA SYSTEM, VEHICLE AND METHOD

(71) Applicant: Continental Automotive Technologies GmbH, Hannover (DE)

(72) Inventor: Thomas Smits, Straelen (DE)

(73) Assignee: Continental Automotive Technologies GmbH, Hannover (DE)

(21) Appl. No.: 18/996,173

(22) PCT Filed: Jun. 13, 2023
(86) PCT No.: PCT/DE2023/200118

§ 371 Date: Jan. 17, 2025

(30) Foreign Application Priority Data
Jul. 20, 2022 (DE) 10 2022 207 415.7
Dec. 7, 2022 (DE) 10 2022 213 225.4

(51) Int. Cl. G06T 7/80; B60R 11/00; B60R 11/04; G06T 7/60

(52) U.S. Cl. CPC G06T 7/80; B60R 11/04; G06T 7/60; B60R 2011/004; G06T 2207/20221; G06T 2207/30244; G06T 2207/30252

(57) ABSTRACT

The disclosure relates to a camera system for a vehicle, comprising at least one computing unit, wherein the camera system is configured to generate a local geometric model of at least one mobile camera unit of the vehicle. The disclosure provides that the camera system is configured to merge a specified global geometric a-priori model of the vehicle with the local geometric model of the vehicle of the at least one mobile camera unit and at least one further local geometric model of the vehicle to form a global model of the vehicle, and to determine a location of the at least one mobile camera unit in the global model of the vehicle.

### DESCRIPTION

The invention relates to a camera system for a vehicle, a vehicle that has a camera system, and a method for operating a camera system.

Camera systems are provided in vehicles to allow a driver to see at least one predetermined camera field of view. To enable this, camera units can be arranged at specified locations on the vehicle. A camera image of the respective camera field of view can in this case be reproduced on a screen in the vehicle. The camera systems can for example be designed as mirror replacement systems or as an all-round visibility camera system which makes it possible to see all around the vehicle or observe the vehicle from above.

Particularly in the case of trucks and/or trailer systems, it is common to arrange permanently installed camera units at specified locations to assist a driver when maneuvering the vehicle.

In order to enable a flexible arrangement of camera systems, mobile camera units exist according to the prior art, which can be arranged by the driver at fixed or freely choosable positions on the vehicle. This makes it possible for the driver, in certain situations, to arrange a camera unit on the vehicle in order to provide a camera recording of a camera field of view.

Particularly in the case of mobile camera systems, this results in the problem that accurate coordinates of the individual camera units would have to be known in order to enable merging of the camera recordings of the respective camera fields of view to form an overall recording of an overall field of view. In contrast to permanently installed camera systems, it is not possible here to calibrate the camera system beforehand. The camera system must therefore be recalibrated in each operation. According to the prior art, this is not possible in an appropriate time period however.

Camera systems, particularly surround view systems are very widespread in today's passenger cars and to some extent already belong to standard equipment. In commercial vehicles, propagation is likewise increasing. However, diverse difficulties/challenges stand in the way of further propagation in this vehicle segment. These include relatively high costs owing to small vehicle production runs, design properties of the vehicles and thus the development of the overall surround field of view. Attachments and trailers that are connected to the towing vehicle in a movable manner necessitate the correction of fields of view. Long cable connections to movable attachments or long trailers, particularly in the case of agricultural machines, sometimes having two trailers coupled one behind the other, are undesired. Attachments or trailers that are exchanged frequently cannot all be equipped with a high-priced permanent installation

Furthermore, in case of doubt, these attachments or trailers that are exchanged do not belong to the vehicle owner, so no actual permanent installation on external devices can be carried out here.

Furthermore, permanently installed systems must be calibrated in a complicated manner. A mobile surround view system has hitherto not been available on the market, because camera units that are temporarily attached to vehicles by means of suction cups or magnets have arbitrary positions or alignments with respect to the vehicle itself. For a surround view system, all camera units must furthermore be calibrated with respect to one another. Deviations due to non-deterministic individual alignments of the camera units add up in the camera group during stitching of the fields of view during operation.

It is an object of the invention, for the described vehicle segment, to provide a mobile self-calibrating camera system.

The object is achieved by the subjects of the independent patent claims. Advantageous developments of the invention are disclosed by the features of the dependent patent claims, the following description and the figures.

The invention relates to a camera system for a vehicle, comprising at least one computing unit that has at least one processor. The camera system comprises at least one mobile camera unit. In other words, the invention is concerned with the camera system which is configured to capture an environment of the vehicle by means of at least one mobile camera unit. The at least one mobile camera unit is in this case configured for arrangement on a respective dropside of the vehicle. The at least one mobile camera unit is configured to capture a respective camera field of view. The camera field of view can in particular have an opening angle greater than 180°. The at least one mobile camera unit in this case is not permanently arranged on the vehicle. The at least one mobile camera unit can for example be arranged, as required, on a predetermined holder or fastened as desired on a dropside of the vehicle. The location of the at least one mobile camera unit on the vehicle may therefore be different at the respective operating times. As a result, in contrast to camera units permanently arranged on the vehicle, it is not possible to store the location of the at least one mobile camera unit in the camera system beforehand or to calibrate the camera system for use of the at least one mobile camera unit ex-works. The camera system is configured to capture geometric parameters of the respective dropside in the camera field of view of the at least one mobile camera unit. In other words, it is provided that the camera unit is configured to capture the dropside, to which it is fastened, in its camera field of view. The camera system is configured to capture geometric parameters of the respective dropside in the camera field of view of the camera unit. The geometric parameters may for example relate to edges and/or corners, points or surfaces of the respective dropside and/or the vehicle. The geometric parameters may for example describe lengths, locations, positions, angles or surface areas. The camera system is configured to capture an orientation of the at least one mobile camera unit in a specified vehicle coordinate system. The orientation may for example describe an alignment of the at least one mobile camera unit in relation to the vehicle and for example specify a type of the dropside on which this mobile camera unit is arranged. The type of the dropside may for example describe a side dropside or a rear dropside of the vehicle. The orientation may for example describe a fundamental direction, such as for example to the front, to the rear, to the right, to the left, upward or downward with respect to the vehicle, without specifying an exact alignment. The camera system is configured to generate a local geometric model of the vehicle of the at least one mobile camera unit depending on the geometric parameters of the respective dropside and the orientation of the at least one mobile camera unit in the specified vehicle coordinate system. The local geometric model of the vehicle may relate to an environment of the mobile camera unit and for example describe the respective dropside and/or a location of the respective at least one mobile camera unit in the respective dropside. It may be provided that the local geometric model comprises dimensions of the respective dropside which were determined by the camera system based on the geometric parameters. It may be provided that the local geometric model describes a left sidewall. The local geometric model may for example comprise dimensions between the respective edges of the sidewall. The local geometric model may also comprise the position at which the mobile camera unit is located inside the sidewall. The position of the mobile camera unit inside the sidewall may for example be described by distances from side edges of the dropside. The position of the mobile camera unit may also describe a twisting of the mobile camera unit with respect to the edges. One possible method for self-localization of one of the camera units is disclosed for example in DE10 2019 202 269 A1.

It is provided that a specified global geometric a-priori model of the vehicle is stored in the camera system. The specified global geometric a-priori model describes assumptions with respect to the geometric parameters of the vehicle. It may be provided that due to the global geometric a-priori model, an assumption is specified, that the vehicle is a truck that has a square shape. In this case, it may be assumed that the dropsides have normal vectors that are aligned orthogonally to one another and opposite dropsides have identical dimensions of the edges or others of the geometric parameters.

The camera system is configured to merge the specified global geometric a-priori model of the vehicle with the local geometric model of the vehicle of the at least one mobile camera unit and at least one further local geometric model of the vehicle to form a global model of the vehicle. In other words, it is provided that the specified geometric a-priori model of the vehicle specifies the assumptions of the geometric parameters. These can be fixed as boundary conditions or adjusted depending on captured geometric parameters.

In order to be able to determine the global model of the vehicle, the camera system is configured to merge the local geometric models of the vehicle based on the assumptions specified by the a-priori model. The local geometric model generated by the at least one mobile camera unit is in this case combined with at least one further local geometric model. The at least one further local geometric model may for example be a local geometric model determined for a further mobile camera unit of the camera system or a local geometric model determined for a permanent camera unit of the vehicle. The geometric a-priori model can for example be stored in the computing unit of the camera system. It may also be provided that it is possible by means of the computing unit to read the geometric a-priori model out from a vehicle control device of the vehicle or a camera system that is permanently installed in the vehicle.

The camera system is configured to determine a location of the at least one mobile camera unit in the global geometric model of the vehicle. In other words, it is possible owing to the combination of the local geometric models according to the assumptions of the a-priori model to determine the global location of the camera unit in the global model of the vehicle from a location determined in a local geometric model of the vehicle. It may be provided that geometric parameters of the respective dropside, on which the at least one mobile camera unit is arranged, are known due to the local geometric model of the camera unit. The location of the camera unit may also be known in the local geometric model. As the global geometric a-priori model of the vehicle is taken into account, it is possible to determine from it which location the camera unit has with respect to the whole vehicle.

Due to the determination of the location of the at least one mobile camera unit in the global geometric model of the vehicle, it is possible to calibrate the camera system for merging recordings of the respective camera unit. Due to the known location of the at least one mobile camera unit in the global geometric model of the vehicle, it is possible to determine by means of the camera system which camera field of view of the camera unit can be captured in relation to the vehicle. This makes it possible to combine the camera field of view of the at least one mobile camera unit with further camera fields of view of respective camera units.

The presented camera system makes it possible to operate mobile wireless camera units cooperatively as a surround view system. In this case, no complicated and time-intensive calibrations by the user are required. The user can attach the camera units ad hoc to different vehicle sides and then be able to see the desired field of view in a camera-overarching manner as a continuous area. Due to the use of mobile wireless camera units, the problems described in the introduction are solved and the presented application is enabled for the first time.

The computing unit of the camera system can in particular be understood to mean a data processing device which contains a processing circuit. In particular, the computing unit can therefore process data to perform computing operations. This also includes, if applicable, operations for performing indexed accesses to a data structure, for instance to a look-up table (LUT).

In particular, the computing unit can contain one or more computers, one or more microcontrollers and/or one or more integrated circuits, for example one or more application-specific integrated circuits (ASICs), one or more field-programmable gate arrays (FPGAs), and/or one or more systems on a chip (SoCs). The computing unit can also have one or more processors, for example one or more microprocessors, one or more central processing units (CPUs), one or more graphics processing units (GPUs) and/or one or more signal processors, in particular one or more digital signal processors (DSPs). The computing unit can also contain a physical or a virtual cluster of computers or others of the units mentioned.

In various exemplary embodiments, the computing unit contains one or more hardware and/or software interfaces and/or one or more memory units.

A memory unit can be configured as a volatile data memory, for example a dynamic random access memory (DRAM) or a static random access memory (SRAM), or a non-volatile data memory, for example a read-only memory (ROM), a programmable read-only memory (PROM), an erasable programmable read-only memory (EPROM), an electrically erasable read-only memory (EEPROM), a flash memory or flash EEPROM, a ferroelectric random access memory (FRAM), a magnetoresistive random access memory (MRAM), or a phase-change random access memory (PCRAM).

The invention also includes developments that result in further advantages.

A further development of the invention provides that the camera system comprises at least two of the camera units and the camera system to be configured to check the plausibility of respective captured data of the at least two camera units and/or geometric parameters of the at least two camera units. It may be provided that respective captured data are generated by the at least two camera units, which data describe the camera field of view of the respective camera unit. For example, the captured data may be image data of a camera image. Based on the respective captured data, the respective geometric parameters and/or the respective local models of the camera units can be determined. The captured data and/or the geometric parameters may exhibit fluctuations however owing to measurement inaccuracies. For example, it may be the case that an edge of the respective dropside was not completely captured and therefore the geometric parameters in relation to the edge are incomplete. It may also be the case that the position of one of the at least two camera units could not be determined because only a particular section of the dropside was detected. Taking the a-priori model into account, the respective captured data of the at least two camera units and/or the geometric parameters can be merged and/or the plausibility thereof can be checked. It may for example be assumed due to the specified global geometric a-priori model of the vehicle that opposite dropsides have identical dimensions and thus at least a few of the geometric parameters of the opposite dropsides are identical. In the context of the detection process, captured data in this case can be exchanged between the two camera units and/or deviations between geometric parameters of the at least two camera units can be determined. In this case, missing geometric parameters of one of the local models can be supplemented by geometric parameters of a local model of a different camera unit.

A further development of the invention provides for the camera system to be configured to capture the geometric parameters of the respective dropside in the camera field of view of the camera unit according to a static detection method. The static detection method may for example provide a determination of the vehicle edges or/the vehicle surface of the dropside based on a static image recorded by the camera unit. It may be provided that edges in the image of the camera field of view are detected by means of edge detection algorithms. The static detection method can for example capture edges based on contrast differences.

A further development of the invention provides for the camera system to be configured to capture the geometric parameters of the respective dropside in the camera field of view of the camera unit according to a dynamic detection method. It is provided that the dynamic detection method comprises capture of an optical flow. It may be provided that the camera system is configured to identify static and dynamic regions in the camera field of view by means of a comparison of at least two camera images of the camera unit. The static region in this case may comprise no movement-related changes. The dynamic region may relate to image regions which have changed between the at least two camera images owing to a movement of the vehicle. The static region may for example be the dropside, while the dynamic region may describe an environment in the camera image which changed during a movement of the vehicle. For example, a progression of an edge or further geometric parameters of the respective dropside can be determined based on boundaries between dynamic and static regions.

A further development of the invention provides for the camera system to be configured to determine the orientation of the at least one camera unit in the global model depending on an optical flow progression. In other words, the camera system is configured to evaluate the optical flow progression captured during the dynamic detection method and to determine the alignment of the camera unit in the global model for the respective camera unit from the flow progression. It may be provided for example that, during a movement of the vehicle, the respective flow progression is determined for the at least one camera unit, by means of tracking of points or features between two images of the respective camera unit, from the progressions of respective movements of the points. Depending on the flow progression, it is possible to determine whether the camera unit is located on a right, left, front, rear, upper or lower dropside of the vehicle.

A further development of the invention provides that the at least one camera unit comprises an acceleration sensor which is configured to determine a gravitational direction with respect to the at least one camera unit. The camera system is configured to determine a location of the global camera system with respect to an environment from the at least one gravitational direction. In other words, by means of the acceleration sensor it is possible to determine an angle by which the camera is inclined with respect to the gravitational direction that is aligned in the direction of the center of the earth. As a result, at least one rotation of the camera unit can be determined for example.

From the alignment of the at least one camera unit that is determined with respect to the gravitational direction, it is possible to determine the location that the global camera model has with respect to the environment. It may for example be provided that due to a camera unit arranged on a side dropside, a rotation about an axis of rotation normal to the dropside is captured by the acceleration sensor. At the same time, due to a camera unit arranged on a rear dropside, a rotation about an axis of rotation located in the rear dropside by a similar angle can be determined. A rotation of the global vehicle model around the environment can be determined by the camera system from the axes of rotation. For example, an inclination of the vehicle by an angle of an incline on which the vehicle is located may be determined. An angle owing to uneven loading of the vehicle may also be determined. An inclination of the vehicle owing to an acceleration process may likewise be determined and be used for compensating this inclination in an overall image or a camera image.

A further development of the invention provides for the camera system to be configured to determine the orientation of the at least one camera unit in the global model depending on an order of arrangement of the camera units on the vehicle over time. In other words, at least one specified order of arrangement for the arrangement of the camera units is stored in the camera system. The order may relate to an order over time, in which the camera units must preferably be arranged in the vehicle so that it is possible to assign the respective orientation from a sequence over time of the arrangement of the respective camera unit. In other words, the order of the arrangement can be connected with the orientation of the respective camera units. It may for example be provided that the order of arrangement specifies that first a first camera unit is to be arranged on a left dropside of the vehicle, then a second camera unit on a rear dropside of the vehicle and then a third camera unit on a right dropside of the vehicle. The camera units may be identical in this case. The camera system can be configured to capture respective time points of attachment of the respective camera units and assign the respective orientation to the camera units depending on the order of arrangement over time. In said case, the orientation to the left can be assigned to the first camera unit, the orientation to the rear to the second camera unit and the orientation to the right to the third camera unit.

A further development of the invention provides that the camera system has at least one camera unit that is permanently arranged on the vehicle. In other words, it may be provided that at least one of the camera units is permanently arranged at a specified location on the vehicle. It may be provided that the local environment model is stored in the camera system for the at least one camera unit that is permanently arranged on the vehicle.

A further development of the invention provides that the camera system is configured to capture an arrangement of the at least one camera unit by capturing a predetermined movement of the at least one camera unit. It may be provided that the camera system is configured to capture the movements of the camera unit by means of the acceleration sensor of the at least one camera unit. The camera system can be configured to capture predetermined movements which comprise predetermined features and are assigned to an arrangement process of the mobile camera unit on the vehicle and to detect these movements as arrangement of the camera unit on the vehicle. The camera system is configured to capture a time point of the arrangement of the camera unit on the vehicle. The further development results in the advantage that the order of arrangement of the camera units can be captured on the basis of movements of the camera units. Therefore, there is no need for a separate registration method.

A further development of the invention provides that the camera system is configured to merge camera images of the camera fields of view of the respective camera units according to a predetermined merging method to form an overall image of an overall field of view of the camera system. In other words, the camera system is configured to record respective camera images of the respective camera fields of view by means of the camera units. The camera images of the respective camera units are merged according to the merging method in order to generate an overall image of an overall field of view from the camera images of the respective camera fields of view. The merging method may for example comprise what is known as a stitching method for merging the camera images.

A second aspect of the invention relates to a vehicle that has at least one camera system of the first aspect of the invention. The vehicle may for example be a motor vehicle, in particular a passenger car and/or a truck. The term vehicle may also include trailers or vehicle combinations. The vehicle combination may for example comprise at least one towing vehicle and at least one trailer.

A third aspect of the invention relates to a method for operating a camera system for a vehicle. The camera system may have at least one computing unit that comprises a processor and at least one mobile camera unit. The mobile camera unit can be configured to be arranged on a respective dropside of the vehicle for capturing a respective camera field of view. For this purpose, the mobile camera unit may for example comprise a magnet or a different apparatus for the non-permanent arrangement of the mobile camera unit on the vehicle.

In a first step, the respective camera field of view of the camera unit is captured by the at least one camera unit. The capture may for example comprise a recording of a camera image. Geometric parameters of the respective dropside can be captured by the camera system in the field of view of the camera unit. It may be provided that an image recognition algorithm is applied by the camera system, in order to capture the geometric parameters of the respective dropside, for example such as edges or corners, in the camera image of the respective camera field of view.

In a further step, an orientation of the at least one mobile camera unit is captured with respect to the vehicle. In other words, it is determined how the mobile camera unit is oriented on the vehicle.

In a further step, a local geometric model of the vehicle of the at least one camera unit is generated depending on the geometric parameters of the respective dropside and the orientation of the at least one mobile camera unit with respect to the vehicle. In other words, the local geometric model of the vehicle with respect to the camera unit is determined by the camera system depending on the geometric parameters which were captured in the field of view of the respective camera unit by the respective camera unit.

In a further step, a specified global geometric a-priori model of the vehicle, which is stored in the camera system and which comprises assumptions with respect to the geometric parameters of the vehicle, is merged by the camera system with the local geometric model of the vehicle of the at least one mobile camera unit and at least one further local geometric model of the vehicle to form a global geometric model of the vehicle.

A location of the at least one mobile camera unit in the global model of the vehicle is determined by the camera system.

For use cases or application situations that may arise in the method and are not explicitly described here, provision may be made for an error message and/or a request for input of user feedback to be output according to the method and/or for a default setting and/or a predetermined initial state to be set.

The invention also includes developments of the vehicle according to the invention and of the method according to the invention that have features such as have already been described in conjunction with the developments of the camera system according to the invention. For this reason, the corresponding developments of the vehicle according to the invention and the method according to the invention are not described again here.

The invention also covers the combinations of the features of the embodiments described.

An exemplary embodiment of the invention is described below. In the figures:

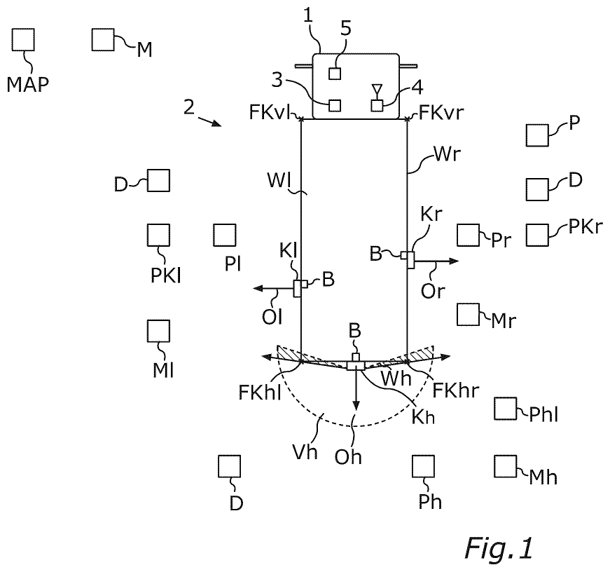

FIG. 1 shows a schematic illustration of a vehicle which has a camera system;

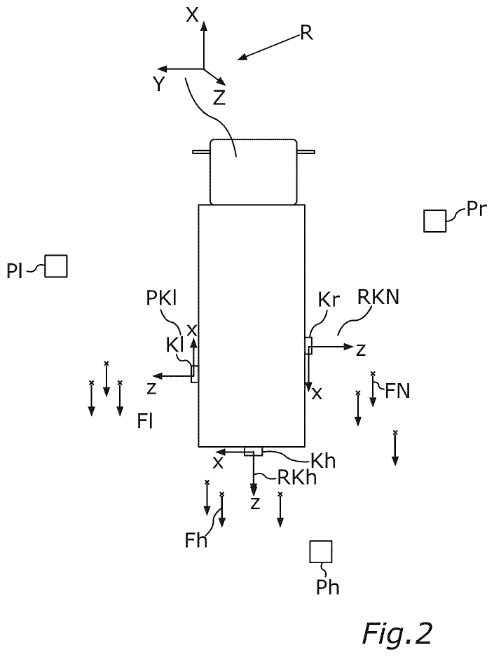

FIG. 2 shows a further schematic illustration of a vehicle;

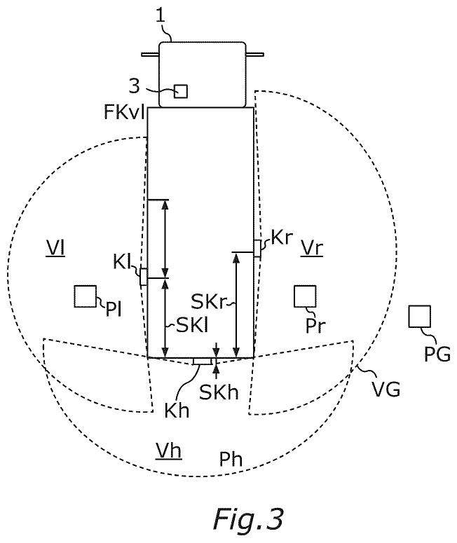

FIG. 3 shows a schematic illustration of an overall field of view;

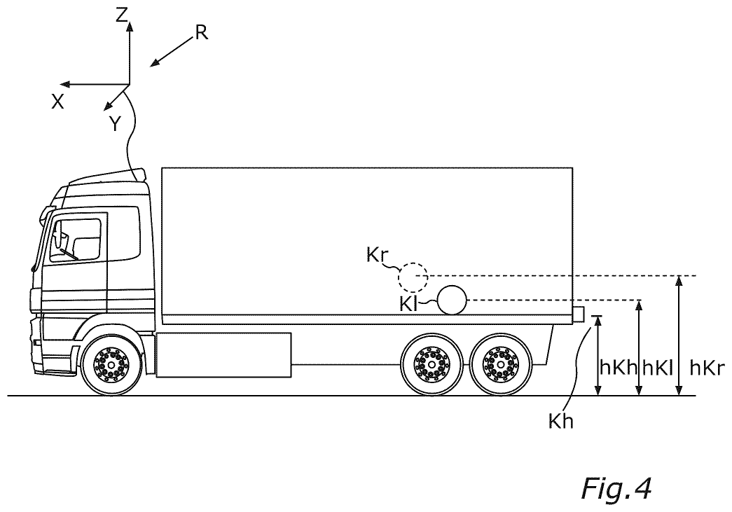

FIG. 4 shows a determination of the heights of the camera units in relation to the coordinate system of the vehicle;

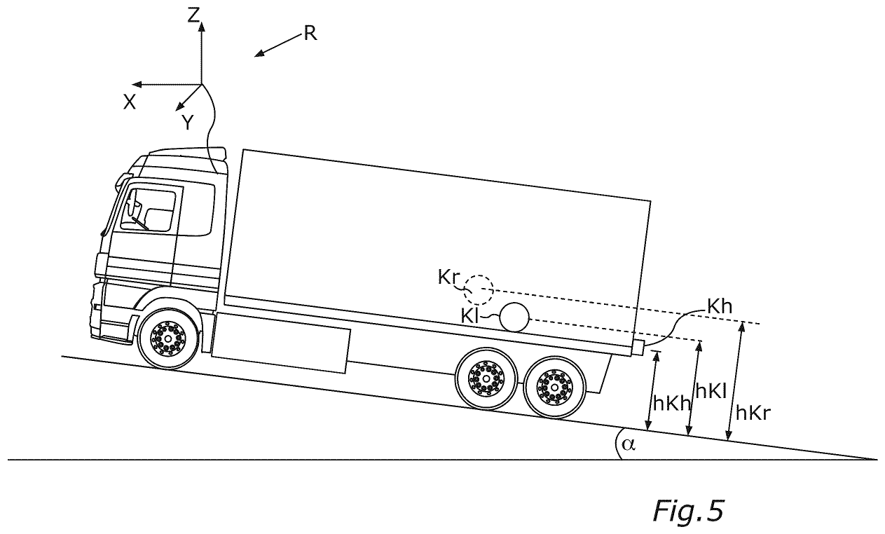

FIG. 5 shows a schematic illustration of the vehicle on a rising plane;

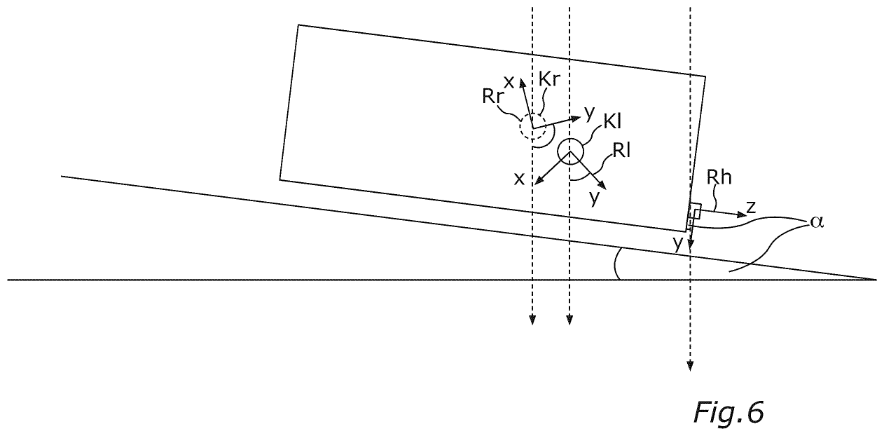

FIG. 6 shows capture of an angle α by means of acceleration sensors; and

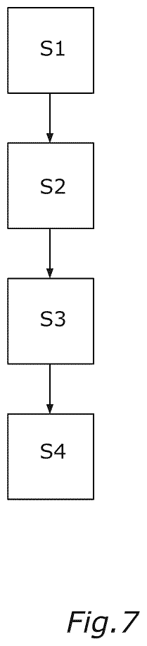

FIG. 7 shows a schematic illustration of a sequence of a method.

The exemplary embodiment explained below is a preferred embodiment of the invention. In the exemplary embodiment, the described components of the embodiment each constitute individual features of the invention that should be considered independently of one another, that each also develop the invention independently of one another and that should thus also be considered to be part of the invention individually or in a combination other than that shown. Furthermore, the embodiment described may also be supplemented by further features of the invention that have already been described.

In the figures, functionally identical elements are each provided with the same reference signs.

FIG. 1 shows a schematic illustration of a vehicle which has a camera system.

The motor vehicle 1 can in particular be a truck. The camera system 2 may have a computing unit 3 and one or more camera units Kl,Kr,Kh. The camera units Kl,Kr,Kh can be what are known as mobile camera units Kl,Kr,Kh that can be arranged on a respective dropside Wl,Wr,Wh of the vehicle 1. The camera units Kl,Kr,Kh can be configured to capture respective camera fields of view Vl,Vr,Vh optically. The vehicle 1 may have a vehicle control device 4. It may be provided that the camera system 2 is configured to merge camera images Pl,Pr,Ph of the respective camera units Kl,Kr,Kh, which depict the respective camera fields of view Vl,Vr,Vh of the respective camera units Kl,Kr,Kh, in a predetermined merging method to form an overall image PG of an overall field of view VG, in order to make it possible for a driver to perceive the overall field of view VG and/or to provide the overall image PG to an evaluation device of the vehicle 1. The merging method can also provide merging in order to be able to depict a subregion of the overall field of view VG in an overall image PG or in order to supplement a shaded region of one of the camera fields of view Vl,Vr,Vh of one of the camera units Kl,Kr,Kh by means of image sections of a camera image Pl,Pr,Ph of a further one of the camera units Kl,Kr,Kh. As a result, it may be possible to provide camera regions Vl,Vr,Vh that are not visible for one of the camera units Kl,Kr,Kh by means of another of the camera units Kl,Kr,Kh. The camera units Kl,Kr,Kh can be arranged on respective dropsides Wl,Wr,Wh of the vehicle 1, which have a respective orientation OKl,OKr,OKh with respect to the vehicle 1. In order to enable merging of the camera images Pl,Pr,Ph to form an overall image PG, it may be necessary to know respective global locations PKl,PKr,PKh of the camera units Kl,Kr,Kh in a global model of the vehicle 1. The respective global location PKl,PKr,PKh of the respective camera unit Kl,Kr,Kh can describe a position and an alignment of the respective camera unit Kl,Kr,Kh.

The camera units Kl,Kr,Kh can for example have a capture angle 15 greater than 180°, so they can capture edges of their dropsides Wl,Wr,Wh for example. The camera units Kl,Kr,Kh can be configured as fisheye cameras. The camera system 2 can be configured to determine geometric parameters P of the respective dropsides Wl,Wr,Wh. The determination can take place based on the respective camera images Pl,Pr,Ph of the respective camera units Kl,Kr,Kh. From the geometric parameters P, which may have been determined for the respective camera units Kl,Kr,Kh, a local model Ml,Mr,Mh of the vehicle 1 can be determined by the camera system 2, which can describe the respective dropside Wl,Wr,Wh based on the camera images Pl,Pr,Ph of the respective camera unit Kl,Kr,Kh. The local model Ml,Mr,Mh may also comprise a location PKl,PKr,PKh of the camera unit Kl,Kr,Kh in the dropside Wl,Wr,Wh. A local location PKl,PKr,PKh of the camera unit Kl,Kr,Kh on the dropside Wl,Wr,Wh in the local model Ml,Mr,Mh of the respective camera unit Kl,Kr,Kh may not be sufficient to enable the merging of the camera images Pl,Pr,Ph of the respective camera units Kl,Kr,Kh. For this purpose, it may be necessary to merge the respective local models Ml,Mr,Mh of the vehicle 1 to form a global model of the vehicle 1, in order to be able to determine the global locations PKl,PKr,PKh of the camera units Kl,Kr,Kh in a vehicle reference system R. To derive the global model and the global locations PKl,PKr,PKh from the local vehicle models, a geometric a-priori model MAP of the vehicle 1 can be stored in the camera system 2.

The geometric a-priori model MAP of the vehicle 1 may be based on it being possible to assume particular geometric properties in the case of vehicles 1 or trailers, which relate to assumptions with respect to the geometric parameters P of the vehicle 1.

Depending on the vehicle type, it is for example possible in the case of a “rigid truck” to assume a vehicle chassis and various superstructures. The superstructure may be very specific in each case for the diverse applications. A superstructure for construction materials generally has what are known as dropsides Wl,Wr,Wh with only a small height. Box-type superstructures by contrast or containers offer a closed space with rear doors. Of course, very many more different types exist. In the majority of vehicle 1 or trailer variants, one can, with respect to the dropsides Wl,Wr,Wh of the vehicle 1, in any case assume a front wall, two sidewalls and a rear wall in the form of doors, a tailgate or liftgate. This is true for trucks and also for trailers in the agricultural sector or in the construction sector. It is common to all of them that the dropsides Wl,Wr,Wh are arranged geometrically at a 90° angle to one another. The invention makes use of this aspect among others as a-priori knowledge. The arrangement in the 90° angles can be specified as an assumption with respect to the geometric parameters P of the vehicle 1 in the a-priori model MAP.

The a-priori model MAP can comprise this or other assumptions with respect to the geometric parameters P of the vehicle 1. The a-priori model MAP can for example specify that particular geometric parameters P of opposite dropsides Wl,Wr,Wh or adjacent dropsides Wl,Wr,Wh are identical and/or have particular relations to one another. It may for example be specified by the a-priori model MAP that a surface of the left dropside Wl of the vehicle 1 matches a surface of the right dropside Wr of the vehicle 1 and therefore edges of the two dropsides Wl,Wr have identical distances from one another. It may also be provided that it is specified by an assumption of the a-priori model MAP that the left dropside Wl and the right dropside Wr in each case have a common edge with the rear dropside Wh. The two edges FKhl,FKhr of the rear dropside Wh may have identical lengths. The global model M of the vehicle 1 can be determined, based on the assumptions of the a-priori model MAP, from a combination of the local model Ml which describes the dropside Wl and the local location PKl of the camera unit Kl on the left dropside Wl with a local model Mr which describes the dropside Wr and the local location PKr of the camera unit Kr on the right side.

To determine the respective orientation OKl,OKr,OKh of the respective camera units Kl,Kr,Kh, the camera system 2 can be configured to determine the orientation OKl,OKr,OKh of the respective camera units Kl,Kr,Kh for example depending on an order of arrangement over time of the camera units Kl,Kr,Kh on the vehicle 1. It may be provided that the order is stored in the computing unit 3 of the camera system 2. This order can specify that first a first of the camera units Kl is to be arranged on the left dropside Wl, then a second of the camera units Kh on the rear dropside Wh and then a third of the camera units Kr on the right dropside Wr. The arrangement of the camera units Kl,Kr,Kh can be captured for example by an acceleration sensor B of the respective camera units Kl,Kr,Kh. This may also be configured to determine an alignment of the gravitational direction G with respect to the respective camera unit Kl,Kr,Kh.

In addition to exclusively mobile camera units Kl,Kr,Kh, camera units permanently installed on the vehicle 1 can of course also be included and supplement the overall field of view of the mobile camera units Kl,Kr,Kh that is present to form a larger continuous overall field of view VG. Here, this is not necessarily concerned with implementing a “classic” surround view system with complete all-round visibility, but rather the development of continuous areas that emerge situationally for the respective task. This may for example also be limited to two camera units Kl,Kr,Kh, in the case of which the one camera field of view Vl,Vr,Vh of the other mobile or permanent camera unit Kl,Kr,Kh is supplemented merely ad hoc. Thus, it may for example be desirable for particular work processes, such as maneuvering with a trailer into a hall, to provide the rear camera field of view Vh and one of the side camera fields of view Vl,Vr. Here, two camera units Kl,Kr,Kh would be sufficient. In this case, a trailer may for example be present without any installation, so that two mobile camera units Kl,Kr,Kh could be required. Likewise, a permanently installed reversing camera unit may however already be present, which is temporarily supplemented by a further mobile camera unit Kl,Kr,Kh. Further different configurations are conceivable, such as for example a permanently installed reversing camera, a mobile camera unit Kr on the right and a mobile camera unit Kl on the left. Provision may also be made for using a mobile camera unit Kl on the left and a mobile camera unit Kh at the rear. Overall, any desired combinations are possible.

The at least one mobile camera unit Kl,Kr,Kh may be identical to a camera unit Kl,Kr,Kh in connection with a method disclosed in DE 10 2019 202 269 A1. The method presented in DE 10 2019 202 269 A1 enables the self-localization of the mobile camera unit Kl,Kr,Kh on a sidewall of a vehicle 1 which is preferably a truck or trailer. It is possible to assume particular geometric properties for this type of vehicle 1 or trailer. These can be specified as assumptions with respect to the geometric parameters P of the vehicle 1 in the a-priori model MAP of the vehicle 1. Depending on the type of the vehicle 1, one can for example, in the case of a “rigid truck”, assume a vehicle chassis and various superstructures. The superstructure may be very specific in each case for the diverse applications. A superstructure for construction materials generally has what are known as dropsides Wl,Wr,Wh with only a small height. Box-type superstructures by contrast or containers offer a closed space with rear doors. Of course, very many more different types exist. In the majority of vehicle variants and/or trailer variants, in an a-priori model MAP, one can in any case assume a front wall, two sidewalls and a rear wall in the form of doors, a tailgate or liftgate as dropsides Wl,Wr,Wh. This is true for trucks and also for trailers in the agricultural sector or in the construction sector.

It is common to all of them that the dropsides Wl,Wr,Wh can be arranged geometrically at a 90° angle to one another. The camera system 2 makes use of this aspect among others as a-priori knowledge, which can be stored in the camera system 2 as a global geometric a-priori model MAP of the vehicle 1. By way of example, a camera system 2 with three mobile camera units Kl,Kr,Kh is described in FIG. 1. The three mobile camera units Kl,Kr,Kh, which may correspond to those of DE 10 2017 208 592 A1, can be attached on the vehicle 1 by a user. They walk around the vehicle 1 and in each case attach one of the mobile camera units Kl,Kr,Kh to the side on the left Wl, one of the mobile camera units Kl,Kr,Kh to the rear wall Wh at the rear and one of the mobile camera units Kl,Kr,Kh to the side on the right Wr. In this case, the user does not need to pay attention to a centimeter-precise positioning on the respective dropside Wl,Wr,Wh, but rather places the camera units Kl,Kr,Kh roughly where they would like to have a field of view Vl,Vr,Vh and of course only at positions that they can reach comfortably, without a ladder, from the floor when walking past.

Detecting/determining the camera positions and the alignments: The advance placement of the mobile camera units Kl,Kr,Kh results in the following relationships of the mobile camera units with respect to one another. The camera units Kl,Kr,Kh lie flat on the respective dropside Wl,Wr,Wh and look orthogonally away from the respective dropside Wl,Wr,Wh in a respective orientation OKl,OKr,OKh. The camera units Kl,Kr,Kh can be arranged at different heights in each case. The camera unit on the left Kl at height hKl, the camera unit at the rear Kh at height hKh and the camera unit on the right Kr at the height hKr. Likewise, the mobile camera units Kl,Kr,Kh can have a different distance from the rear wall sKl,sKh,sKr. Each of the mobile camera units Kl,Kr,Kh has an arbitrary rotation about a separate Z axis with respect to the vehicle coordinate system R. Each of the mobile camera units Kl,Kr,Kh looks in a different orientation Ol,Or,Oh and therefore has a rotation that is offset by approximately 90° or 180° about its own y axis with respect to the other camera units Kl,Kr,Kh or the vehicle coordinate system R. The method from DE 10 2019 202 269 A1 can then be applied for each of the mobile camera units Kl,Kr,Kh in order to determine a location PKl,PKr,PKh of the respective camera unit Kl,Kr,Kh.

As a particular feature, it is true here however that due to the different placement/orientation OKl,OKr,OKh, each camera unit Kl,Kr,Kh sees a different environment in its camera field of view Vl,Vr,Vh. During forward travel, the camera unit on the left Kl sees a predominant optical flow Fl along the x axis in the negative direction, the camera unit on the right Kr sees a predominant optical flow Fr along the x axis in the positive direction and the camera unit Kh sees a predominant optical flow along the Z axis in the positive direction. When using a plurality of camera units Kl,Kr,Kh, it is possible in addition to call upon further a-priori knowledge in assumptions with respect to the geometric parameters P of the vehicle 1 in a global geometric a-priori model MAP of the vehicle 1. Thus, the camera units Kl,Kr,Kh can transmit geometric parameters P that are already recognized to one another. One example for geometric parameters P may be the upper and lower horizontal edge of a side wall as dropside Wl,Wr. The assumptions of the a-priori model MAP of the vehicle 1 may include the dropsides on the left and right Wl,Wr having a same height dimension in each case, as the vehicle 1 is built symmetrically. In general, the rear wall, at least the upper edge, also has the same height. Furthermore, the assumptions of the a-priori model MAP of the vehicle 1 may include the vertical edges of the side wall forming a 90° angle to the horizontal edges. If it was possible to determine lengths of the left side wall Wl successfully, the plausibility of this can be checked against the opposite right side wall Wr.

The mutual plausibility checking and weighting/filtering can take place on the basis of all described data. This may accelerate the initial static detection considerably for example or increase the confidence. This concept can likewise be applied for the dynamic detection of the edges by means of the optical flow Fl,Fr,Fh. It is known how the respective optical flows Fl,Fr,Fh must behave with respect to one another on average. After the vehicle edges or surfaces have been determined, it is possible, by relating the orientation of the edges to the orientation OKl,OKr,OKh of the image sensor of the respective camera unit Kl,Kr,Kh, to determine the respective rotation on the respective side surface Wl,Wr,Wh.

Consequently, all relevant parameters P of respective local geometric models Ml,Mr,Mh are then known with respect to the respective camera units Kl,Kr,Kh. Each of the camera units Kl,Kr,Kh knows the vehicle side to which it is attached, knows the position on the respective surface and knows its own rotation and its height with respect to one another.

Using the previously mentioned knowledge about the geometric circumstances of the vehicle 1 or trailer, the respective camera images Pl,Pr,Ph of the respective dropside Wl,Wr,Wh can be aligned and merged to form an overall image PG. The camera images Pl,Pr,Ph can be rotated and cropped so that they are aligned, for example, exactly to the rear vertical and the horizontal edges or the points of intersection thereof. The individual camera images Pl,Pr,Ph can then be transformed and merged to form the overall image PG. For example, a common sphere may be formed, in which the individual fields of view Vl,Vr,Vh adjoin one another.

The following convention may optionally be used in order to accelerate the detection process at the start or configure it more robustly. To this end, a specified order of arrangement of the camera units Kl,Kr,Kh over time could be specified. If the camera units Kl,Kr,Kh are placed by the user in the specified order, the respective orientation OKl,OKr,OKh of the camera units Kl,Kr,Kh could be determined from that. The order could specify that starting from the driver side, the first camera unit Kl,Kr,Kh is placed on the vehicle side on the left, then the second camera unit Kl,Kr,Kh is placed on the rear side and the third camera unit Kl,Kr,Kh is finally placed on the right side. If the user holds to this convention, each camera unit Kl,Kr,Kh could learn the vehicle side on which it was placed already prior to movement of the vehicle 1. To this end, only the acceleration sensor B needs to be monitored and a corresponding jump or behavior when attaching the camera unit Kl,Kr,Kh by means of the strong magnets needs to be detected. The camera unit Kl,Kr,Kh can capture the respective time point and exchange/synchronize it with the other camera units Kl,Kr,Kh and thus determine the order and therefore the vehicle side on which it was attached. Each camera unit Kl,Kr,Kh may be identical in this case and therefore does not have to have a specified number. Optionally, one or more camera units Kl,Kr,Kh can be permanently installed on the vehicle 1 and supplemented by further mobile camera units. The permanently installed camera units Kl,Kr,Kh may have access to the vehicle bus and optionally obtain the geometric parameters P of the vehicle 1 from a vehicle control device and store same in the a-priori model MAP of the vehicle 1. The geometric parameters P of the vehicle 1 can be provided to the other camera units Kl,Kr,Kh as a result, so that the geometric parameters P can be used for detection in a profitable manner. Alternatively, instead of the permanently installed camera units, the camera units may be wireless mobile camera units Kl,Kr,Kh which are connected to the vehicle 1 in a defined manner by means of a camera holder, as is disclosed in DE 10 2018 218 735 A1.

FIG. 2 shows a further schematic illustration of a vehicle 1.

It may be provided that the geometric parameters P and the local locations PKl,PKr,PKh of the respective camera units Kl,Kr,Kh in the respective local models Ml,Mr,Mh are specified with respect to respective local coordinate systems RKl,RKr,RKh of the respective camera units Kl,Kr,Kh, wherein a Z direction of the respective camera unit Kl,Kr,Kh is defined in a viewing direction of the camera unit Kl,Kr,Kh and an X and Y direction are defined with respect to a rear wall of the respective camera unit Kl,Kr,Kh. If it is assumed that the respective camera units Kl,Kr,Kh rest PKl,PKr,PKh flat on the dropsides Wl,Wr,Wh and the respective dropsides Wl,Wr,Wh are aligned orthogonally, it may be assumed that the directions X and Y of the local coordinate systems RKl,RKr,RKh lie in a plane of the respective dropside Wl,Wr,Wh. The global coordinate system R of the vehicle 1 can be defined in such a manner that an X direction is aligned in a vehicle longitudinal direction, a Y direction is aligned in a transverse direction of the vehicle 1 and a Z direction is normal to a top side of the vehicle 1.

After the user has placed the camera units Kl,Kr,Kh on the vehicle 1, an immediate availability of the system is desirable. For the individual detection according to DE 10 2019 202 269 A1 however, in addition to the static detection, the optical flow is additionally evaluated, as uncertainties or ambiguities may additionally emerge if purely static edges are used. As soon as more data are available to the system, these data can be called upon iteratively in each case, in order to then increase the accuracy and robustness. In particular, as soon as the vehicle 1 moves for the first time after placement of the camera units Kl,Kr,Kh, it adapts itself until a satisfactory configuration has been found.

The camera system 2 can be configured to capture the geometric parameters P according to the static detection method and, alternatively or additionally to the static detection method, according to a dynamic detection method. In this case, static image regions, which for example show the dropside Wl,Wr,Wh, and dynamic regions, which show changing regions of the camera images Pl,Pr,Ph, can be identified from a plurality of camera images Pl,Pr,Ph of a respective camera unit Kl,Kr,Kh. The geometric parameters P can be determined for example by means of a detection of boundaries between dynamic and static regions.

By means of the camera system 2, it is also possible to determine a respective optical flow Fl,Fr,Fh for the respective camera units Kl,Kr,Kh when the vehicle 1 moves. For example, individual points in successive camera images Pl,Pr,Ph of a respective camera unit Kl,Kr,Kh can be tracked in order to determine a progression of the optical flow Fl,Fr,Fh from the movements of the individual points. By means of the determination of the optical flow, it is for example possible to determine a respective vector for each of the camera units Kl,Kr,Kh, from which vector a movement of the vehicle 1 with respect to the respective camera unit Kl,Kr,Kh can be determined. From this, it is possible to determine the orientation OKl,OKr,OKh of the respective camera unit Kl,Kr,Kh with respect to the vehicle 1.

In the context of the present disclosure, an object recognition algorithm can be understood to mean a computer algorithm that is able to identify and to localize one or more objects within a provided input data record, for example a camera image, for example in that it determines corresponding bounding boxes or regions of interest (ROI), and in particular assigns a corresponding object class to each of the bounding boxes, wherein the object classes can be selected from a predefined set of object classes. In this case, the assignment of an object class to a bounding box can be understood in such a manner that a corresponding confidence value or a likelihood for the object identified inside the bounding box belonging to the corresponding object class is provided. For example, the algorithm can provide a confidence value of this type or a likelihood for each of the object classes for a given bounding box. The assignment of the object class can for example include the selection or provision of the object class with the largest confidence value or the largest likelihood. Alternatively, the algorithm may also only determine the bounding boxes without assigning a corresponding object class.

A correlation of the camera units Kl,Kr,Kh with respect to one another with regard to the optical flow Fl,Fr,Fh furthermore allows a further optimization, direction, robustness, speed, accuracy. A rotation of the vehicle 1 can also be determined by means of the correlation of the “predominant” optical flows Fl,Fr,Fh. For example, the rotation of the vehicle 1 about the Z axis of the vehicle coordinate system R can be determined or inversely the vehicle trajectory/acceleration can be used to check the plausibility of, to weight or to optimize a correlated optical flow Fl,Fr,Fh or that of the individual camera units Kl,Kr,Kh.

FIG. 3 shows a schematic illustration of an overall field of view VG.

It may be provided that measurement data of the respective camera units Kl,Kr,Kh are exchanged with one another by means of the camera system 2 in order to check the plausibility of recordings and/or geometric parameters P of the respective camera units Kl,Kr,Kh with respect to one another. In this case, geometric parameters P not detected in camera images Pl,Pr,Ph of one of the camera units Kl,Kr,Kh can for example be supplemented by geometric parameters P which were captured in camera images Pl,Pr,Ph of different camera units Kl,Kr,Kh. Captured data D can also be exchanged between the camera units Kl,Kr,Kh, which may for example describe captured line areas. FIG. 3 for example shows that the camera field of view Vl of the left camera unit Kl is not sufficient to capture the entire left dropside Wl. As a result, it is for example not possible to capture the two vertical edges Fkvl, Fkhl of the left dropside Wl and therefore a length of the left dropside Wl. The determination of the geometric parameter P which describes the length of the left dropside Wl may therefore not be possible from the camera image Pl of the left camera unit Kl. Consequently, it may also not be possible to determine a location PKl,PKr,PKh of the left camera unit Kl with respect to the dropside Wl in the local model Ml. The geometric parameter P with respect to the dropside length can be imported from the local model Mr of the right camera unit Kr by utilizing the assumption of the a-priori model MAP that the opposite dropsides on the left and right Wl,Wr are identical. As a result, the local model MI of the left camera unit Kl can be supplemented with geometric parameters P or captured data D of the right camera unit Kr, so that the length of the left dropside Wl is likewise known in same. From a captured distance SKl of the left camera unit Kl from the left edge FKhl, it is possible to determine the location PKl of the camera unit Kl in the left dropside Wl therefrom.

By means of a camera holder, for example via RFID communication, and optional access to the vehicle bus via a wireless connection, by means of a vehicle control device 4 having a vehicle bus connection and wireless connection, the respective camera unit Kl,Kr,Kh can determine its own defined location PKl,PKr,PKh and orientation OKl,OKr,OKh on the vehicle 1 and vehicle data itself and use them in a profitable manner in the detection process in cooperation with the other camera units Kl,Kr,Kh. It is also noted here that the camera units Kl,Kr,Kh operate cooperatively and the detection or substeps can take place to some extent separately, then in a collaboratively distributed manner on the camera units Kl,Kr,Kh or centrally.

In this case, one of the camera units Kl,Kr,Kh can at least temporarily adopt a “master role” and function as computing unit 3 of the camera system 2. Alternatively, a central vehicle control device 4 can also be integrated and the detection can be performed on the vehicle control device 4 completely, in a distributed collaborative manner or temporarily in the master role. Optionally, a following particular feature applies if, in case of doubt, one or more vehicle edges cannot be detected clearly. This may for example relate to the front left vertical vehicle edge FKvl if the camera unit Kl,Kr,Kh is placed really far back and the vehicle 1 is correspondingly long. Here, the system should function in spite of this and, in the case of sufficiently adequately accurate/robust information, for example determine a missing edge from the data of the others or ignore the absence. The field of view of the camera unit Kl on the left can for example be placed in spite of missing edges FKvl. The opening angle of the camera unit Kl,Kr,Kh (or the imager region that is used and is cropped from the overall imager region) could be configured symmetrically. That is to say the field of view of the left camera unit Kl would cover the region from the center of the image sensor up to the rear edge FKhl of the vehicle 1 (distance SKl) and also use this value for the region from the image sensor center forward. Alternatively however, the data of the vehicle 1 that were determined in a different previously described manner may also be used.

FIG. 4 shows a determination of the hKl, hKr, hKh heights of the camera units Kl,Kr,Kh in relation to the coordinate system R of the vehicle.

It may be the case that the camera units Kl,Kr,Kh are arranged at different heights hKl,hKr,hKh. From the local locations of the camera units Kl,Kr,Kh with respect to the respective dropside Wl,Wr,Wh, it is possible, while taking account of the specifications of the a-priori model MAP, to determine the global locations PKl,PKr,PKh of the camera units Kl,Kr,Kh with respect to the vehicle 1 and which heights hKl,hKr,hKh the respective camera units Kl,Kr,Kh have with respect to the vehicle 1.

FIG. 5 shows a schematic illustration of the vehicle 1 on a rising plane. The plane may enclose an angle α with a horizontal plane. As a result, the vehicle 1 may be rotated by the angle α with respect to its environment.

FIG. 6 shows capture of the angle α by means of acceleration sensors B.

As described in DE 10 2019 202 269 A1, the camera unit Kl,Kr,Kh can determine a direction of the gravitation using the integrated acceleration sensor B. Optionally, the respective inclination α of the three camera units Kl,Kr,Kh with respect to the direction of gravitation G can be correlated with one another in order to obtain another optimized detection. To this end, the camera units Kl,Kr,Kh can send the measured values to the acceleration sensors B in a wireless or wired manner in each case. An overall inclination α or rotation of the camera system 2 and thus also of the vehicle 1 can be determined as a result of this. In detail, the rear camera unit Kh can determine the pitch angle α of the vehicle 1 in that the rotation about its own x axis is determined with the aid of the internal acceleration sensor B. This rotation corresponds to the pitch angle α of the vehicle 1 which can be taken into account in the two side cameras Kl,Kr. Here, it is presupposed that the camera unit Kl,Kr,Kh rests flat on the respective dropside Wl,Wr,Wh. Vice versa, the roll angle α of the vehicle 1 can be determined using the rotation of the two side cameras Kl, Kr about their own x axes in each case. Optionally, the speed and acceleration values and inclination of the vehicle 1 can also be called upon in order to optimize the detection even further. All parameters P can be used to optimize the detection, optionally direction accuracy, robustness/plausibility checking or speed.

FIG. 7 shows a schematic illustration of a sequence of a method for operating a camera system 2 for a vehicle 1.

The camera system 2 can have at least one computing unit 3 having a processor and at least one mobile camera unit Kl,Kr,Kh, wherein the at least one mobile camera unit Kl,Kr,Kh is configured for arrangement on a respective dropside Wl,Wr,Wh of the vehicle 1 and for capturing a respective camera field of view Vl,Vr,Vh.

One step S1 can comprise capturing geometric parameters P of the respective dropside Wl,Wr,Wh in the camera field of view Vl,Vr,Vh of the camera unit Kl,Kr,Kh by the camera system 2.

One step S2 can comprise detecting an orientation OKl,OKr,OKh of the at least one mobile camera unit Kl,Kr,Kh in a specified vehicle coordinate system R by the camera system 2.

One step S3 can comprise generating a local geometric model Ml,Mr,Mh of the vehicle 1 of the at least one mobile camera unit Kl,Kr,Kh depending on the geometric parameters P of the respective dropside Wl,Wr,Wh and the orientation OKl,OKr,OKh of the at least one mobile camera unit Kl,Kr,Kh.

One step S4 can comprise merging a specified global geometric a-priori model MAP of the vehicle 1, which comprises assumptions with respect to the geometric parameters P of the vehicle 1, with the local geometric model of the vehicle 1 of the at least one mobile camera unit Kl,Kr,Kh and at least one further local geometric model Ml,Mr,Mh of the vehicle 1 by means of the camera system 2 to form a global model M of the vehicle 1, wherein determination of a location PKl,PKr,PKh of the at least one mobile camera unit Kl,Kr,Kh in the global model M of the vehicle 1 can take place by means of the camera system 2.

The placement of the camera units Kl,Kr,Kh at heights that can be reached by the user and the fact that the camera units Kl,Kr,Kh look orthogonally away from the vehicle 1 may bring advantages for certain situations compared to classically positioned camera units Kl,Kr,Kh in surround view systems. Better perspectives with less distortion and higher resolution can be generated for certain situations.

When reversing or when maneuvering, it is possible to create a less distorted view with higher resolution from the side camera units Kl,Kr,Kh with the rear one. It comes closer to the view that a spotter who is standing next to the vehicle 1 would have. In addition, due to the large opening angle and the lower height, more context of the vehicle 1 can be optically captured. When maneuvering in a hall for example, the camera units Kl,Kr,Kh can also look up and avoid a collision in the case of heights that are too low. A further advantage is the reference to the vehicle edge with regard to the accuracy. In the case of a permanently installed system with camera units Kl,Kr,Kh with an opening angle>180° and a resolution of several megapixels, each tenth of a degree of mechanical deviation, tilting for example, means an effective deviation of a relatively large number of pixel rows in the image. This has considerable influence for example with respect to a distance of for example 2 m from the vehicle edge. When aligning with respect to the vehicle edge, it is possible by implication to align very accurately in terms of granularity of pixel rows.

Overall, the example shows how a mobile self-calibrating surround view system can be provided.

### LIST OF REFERENCE SIGNS

1 Vehicle
2 Camera system
3 Computing unit
4 Control device
5 Order
Kl,Kr,Kh Camera unit
PKl,PKr,PKh Location
P Parameter
B Acceleration sensor
Wl,Wr,Wh Dropside
Vl,Vr,Vh Camera field of view
VG Overall field of view
Pl,Pr,Ph Camera image
PG Overall image
Fl,Fr,Fh Flow progression
G Gravitational direction
M Global model
MAP A-priori model
Ml,Mr,Mh Local model
D Captured data
OKl,OKr,OKh Orientation
R Vehicle reference system
Rl,Rr,Rh Local reference system
hKl,hKr,hKh Heights
sKl, sKh sKr Distance from the rear dropside
FKhl,FKhr,FKvl Edges

1. A camera system for a vehicle, the camera system comprising:
at least one computing unit having a processor; and
at least one mobile camera unit,
wherein the at least one mobile camera unit is configured for arrangement on a respective dropside of the vehicle and for capturing a respective camera field of view (Vl,Vr,Vh),
wherein the camera system is configured to capture geometric parameters of the respective dropside in the camera field of view of the camera unit, to capture an orientation of the at least one mobile camera unit in a specified vehicle coordinate system, to generate a local geometric model of the vehicle of the at least one mobile camera unit depending on the geometric parameters of the respective dropside and the orientation of the at least one mobile camera unit in the specified vehicle coordinate system,
wherein a specified global geometric a-priori model of the vehicle is stored in the camera system, which comprises assumptions with respect to the geometric parameters of the vehicle,
and wherein the camera system is configured to merge the specified global geometric a-priori model of the vehicle with the local geometric model of the vehicle of the at least one mobile camera unit and at least one further local geometric model of the vehicle to form a global model of the vehicle, and to determine a location of the at least one mobile camera unit in the global model of the vehicle.

2. The camera system as claimed in claim 1, wherein the camera system is configured to check the plausibility of respective captured data of at least one of the at least two camera units and geometric parameters of the at least two camera units

3. The camera system as claimed in claim 1, wherein the camera system is configured to capture the geometric parameters of the respective dropside in the camera field of view of the camera unit according to a static detection method.

4. The camera system as claimed in one claim 1, wherein the camera system is configured to capture the geometric parameters of the respective dropside in the camera field of view of the camera unit according to a dynamic detection method, wherein the dynamic detection method comprises capture of an optical flow progression.

5. The camera system as claimed in claim 4, wherein the camera system is configured to determine an alignment of the at least one camera unit in the global model depending on the flow progression.

6. The camera system as claimed in claim 1, wherein the at least one camera unit comprises an acceleration sensor which is configured to determine a gravitational direction with respect to the at least one camera unit and the camera system is configured to determine a location of the global camera system with respect to an environment from the at least one gravitational direction.

7. The camera system as claimed in claim 1, wherein the camera system is configured to determine the orientation of the at least one camera unit depending on an order of arrangement.

8. The camera system as claimed in claim 1, wherein the camera system has at least one camera unit that is permanently arranged on the vehicle.

9. The camera system as claimed in claim 1, wherein the camera system is configured to capture an arrangement of the at least one camera unit by capturing a predetermined movement by the acceleration sensor of the at least one camera unit.

10. The camera system as claimed in one of the preceding claims claim 1, wherein the camera system is configured to merge camera images of the camera fields of view of the respective camera units according to a predetermined merging method.

11. A vehicle, the vehicle comprising:
a camera system comprising:
at least one computing unit having a processor; and
at least one mobile camera unit,
wherein the at least one mobile camera unit is configured for arrangement on a respective dropside of the vehicle and for capturing a respective camera field of view,
wherein the camera system is configured to capture geometric parameters of the respective dropside in the camera field of view of the camera unit, to capture an orientation of the at least one mobile camera unit in a specified vehicle coordinate system, to generate a local geometric model of the vehicle of the at least one mobile camera unit depending on the geometric parameters of the respective dropside and the orientation of the at least one mobile camera unit in the specified vehicle coordinate system,
wherein a specified global geometric a-priori model of the vehicle is stored in the camera system, which comprises assumptions with respect to the geometric parameters of the vehicle, and
wherein the camera system is configured to merge the specified global geometric a-priori model of the vehicle with the local geometric model of the vehicle of the at least one mobile camera unit and at least one further local geometric model of the vehicle to form a global model of the vehicle, and to determine a location of the at least one mobile camera unit in the global model of the vehicle.

12. A method for operating a camera system for a vehicle, wherein the camera system comprises at least one computing unit having a processor and at least one mobile camera unit wherein the at least one mobile camera unit is configured for arrangement on a respective dropside of the vehicle and for capturing a respective camera field of view comprising:
detecting geometric parameters of the respective dropside in the camera field of view of the camera unit by the camera system;
detecting an orientation of the at least one mobile camera unit in a specified vehicle coordinate system by the camera system;
generating a local geometric model of the vehicle of the at least one mobile camera unit depending on the geometric parameters of the respective dropside and the orientation of the at least one mobile camera unit;
merging a specified global geometric a-priori model of the vehicle which comprises assumptions with respect to the geometric parameters of the vehicle with the local geometric model of the vehicle of the at least one mobile camera unit and at least one further local geometric model of the vehicle to form a global model of the vehicle by the camera system; and
determining a location of the at least one mobile camera unit in the global model of the vehicle by the camera system.
